(19) United States
(12) Patent Application Publication
(10) Pub. No.: US 2004/0214706 A1
(43) Pub. Date: Oct. 28, 2004

(54) Method and apparatus for further processing of printed sheets

(75) Inventors: Georg Dannemann, Backnang (DE); Klaus Stocklossa, Marbach (DE); Eberhard Krieger, Weinstadt-Struempfelbach (DE)

Correspondence Address: ROTHWELL, FIGG, ERNST & MANBECK, P.C., 1425 K STREET, N.W., SUITE 800, WASHINGTON, DC, 20005, US

(73) Assignee: Maschinenbau Oppenweiler Binder GmbH & Co. KG, Oppenweiler (DE)

(21) Appl. No.: 10/834,241

(22) Filed: Apr. 29, 2004

(30) Foreign Application Priority Data
May 8, 2003 (EP) 030 010 429.3

(51) Int. Cl. B31F 1/00

(52) U.S. Cl. 493/405

(57) ABSTRACT

In the case of the method by which sheets which are printed, in particular, by a digital-printing machine are processed further to produce multi-leaf printed products, the printed sheets are folded at least once to form a folded sheet, and the folded sheets are collated one above the other. The sheets are folded prior to collation such that the folding edge of the folded sheet is located at the top and the folded sheet opens in the downward direction, with the result that the folded sheets can maintain their position prior to collation.

### FIELD OF THE INVENTION

The invention relates to a method and to an apparatus for further processing of sheets which are printed, in particular, by a digital-printing machine to produce multi-leaf printed products.

### DESCRIPTION OF THE BACKGROUND ART

DE 102 20 550 A1 discloses a method and an apparatus for further processing of printed sheets. The apparatus described in this document has a buckle folder by means of which a sheet is folded transversely to the sheet-running direction. The buckle folder is followed by a knife folder, by means of which the sheet coming from the buckle folder is folded in the sheet-running direction by a folding knife introducing the sheet between two folding rollers which can be rotated in opposite directions. Arranged beneath the folding rollers is a feeder drum, which receives the folded sheet by means of a gripper. A sheet opener formed from two transporting rollers which can be rotated in opposite directions is arranged beneath the feeder drum. Located beneath the sheet opener is a transporting rail, on which the open sheets are set down one above the other. The sheets which are folded by the knife folder pass through the knife folder such that the folding edge is located at the bottom and the sheet opens in the upward direction. The feeder drum turns the sheet such that the folding edge is located at the top and the sheet opens in the downward direction, in order that it can be set down on the transporting rail. The arrangement of the feeder drum for reversing the sheets involves very high outlay in design terms. Furthermore, an additional operating step is necessary in order for the sheet which passes out of the knife folder to be set down on the transporting rail. This reduces the production capacity of the apparatus.

DE 196 10 814 C1 discloses a thread sealing machine in the case of which a sheet-transporting device is followed by a former folder which opens in the upward direction and by means of which a sheet fed by the transporting device is folded such that the folding edge is located at the bottom and the folded-sheet sections extend upwards, with the result that the folded sheet opens in the upward direction. Following the former folder, the folding edge of the folded sheet is pressed by a pressing device having a pair of pressing rollers.

### SUMMARY OF THE INVENTION

The object of the invention is, using means of straightforward design, to provide a method and an apparatus which are intended for processing printed sheets further to produce multi-leaf printed products and make it possible, with relatively low design outlay, to achieve a high production capacity.

This object is achieved according to the invention by a method by means of which sheets which are printed, in particular, by a digital-printing machine are processed further to produce multi-leaf printed products, wherein said printed sheets are folded at least once to form folded sheets, and said folded sheets are collated one above the other, said sheets being folded prior to collation such that the folding edge of said folded sheets is located at the top and said folded sheets open downwardly.

An apparatus for carrying out the method of the present invention comprises a folding device for folding said sheets, downstream of which is provided a collating device, in which said folded sheets are set down one above the other such that a folding edge formed by said folding device is located at the top and said folded sheets open downwardly, wherein said folding device comprises a former folder which opens downwardly.

Since the sheets are folded prior to collation by the former folder, which opens in the downward direction, such that the folding edge of the folded sheet is located at the top and the folded sheet opens in the downward direction, there is no need for a change in the position of the folded sheet for collating purposes once it has left the folding device. The folded sheets can be set down one above the other in the collating device in the position in which they leave the folding device.

The folding quality can be improved by the folding edge being pressed by a pair of pressing rollers following departure from the former folder.

In the case of a preferred embodiment of the apparatus according to the invention, the former folder is provided downstream of a buckle folder. The buckle folder may be configured either such that it folds an incoming sheet transversely to the sheet-running direction or that the sheet can pass through the buckler folder without being folded. This increases the versatility of the apparatus according to the invention.

### BRIEF DESCRIPTION OF THE DRAWINGS

Exemplary embodiments of the invention are explained in more detail hereinbelow with reference to drawings, in which:

FIG. 1 shows, schematically, a side view of an apparatus by means of which printed sheets are processed further to produce multi-leaf printed products,

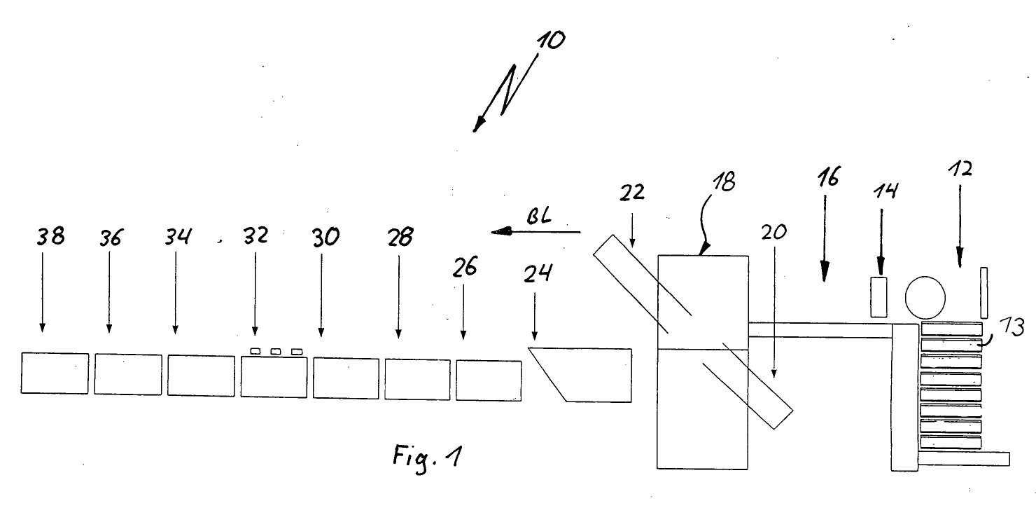

FIG. 2 shows, schematically, the individual operating steps of the apparatus according to the invention with a sheet being folded by a buckle folder, and

FIG. 3 shows the individual operating steps of the apparatus with the sheet passing through the buckle folder without being folded.

### DETAILED DESCRIPTION OF THE INVENTION

The apparatus according to the invention has a sheet feeder 12, on which a plurality of sheet stacks 13 are arranged one above the other. Each sheet stack 13 comprises a multiplicity of sheets which have been printed on their upper side and on their underside by a digital-printing machine. The sheet feeder 12 is followed by an aligning table 16 for aligning and feeding a sheet to a buckle folder 18 with two buckle plates 20, 22. Provided downstream of the buckle folder 18 is a former folder 24, which is arranged such that it opens in the downward direction. The former folder 24 is followed, in the sheet-running direction BL, by a collating device 26 which is known per se and has a chain on which the folded sheets are collected. The collating device 26 is followed by a means 28 for positioning a cover over the sheets collected by the collating device 26. This is followed by a vibrating device 30, which aligns the sheets together with the cover. The vibrating device 30 is followed by a binding device 32, which binds the sheets and the cover together. This is followed by a cutting device 34, which cuts the three sides of the sheets which have not been bound. The cutting device 34 is then followed by a delivery means 36 and a punching device 38.

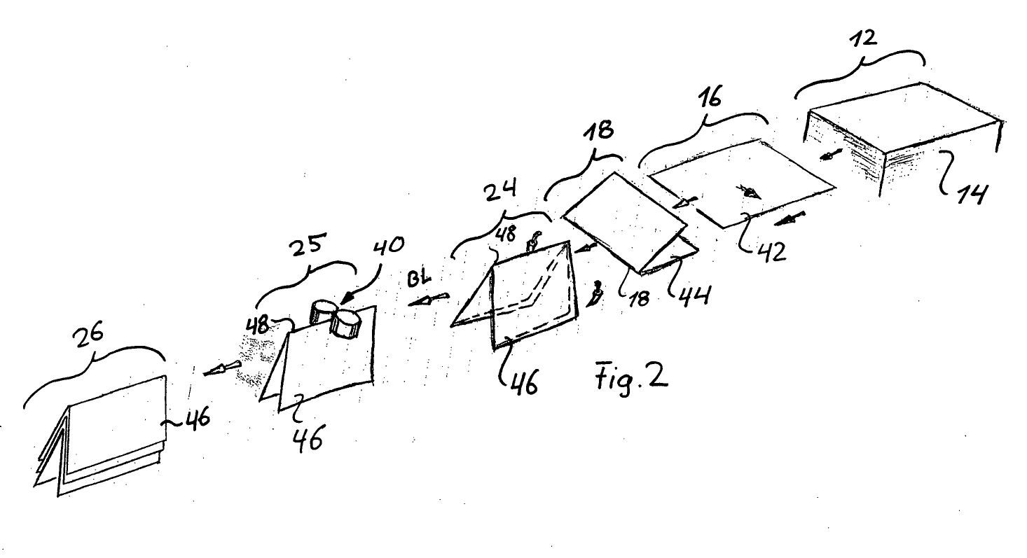

The individual operating steps of the apparatus according to the invention are shown in FIG. 2. A sheet 42 is removed from the sheet stack 13 of the sheet feeder 12 and is aligned on the aligning table 16. In the buckle folder 18, the sheet 42 is folded transversely to the sheet-running direction BL to form a first folded sheet 44. The folded sheet 44 leaves the buckle folder 18 with the folding edge 45 in front and is fed to the former folder 24, which folds the first folded sheet 44 to form a second folded sheet 46, the folding edge 48 of which is at the top and runs horizontally in the sheet-running direction BL, and the second folded sheet 46 opening in the downward direction such that the bottom edges of the second folded sheet 46 are spaced apart from one another.

As can be seen in FIG. 2, it is also possible to provide downstream of the former folder 24 a pressing device 25, which has a pair of pressing rollers 40 which presses the folding edge 48 of the second folded sheet 46 on departure from the former folder 24. Following the pressing device 25, the second folded sheets 46 are set down one above the other in the collating device 26. The operating steps described in FIG. 2 serve for folding sheets on which eight pages of the final multi-leaf printed product have been printed.

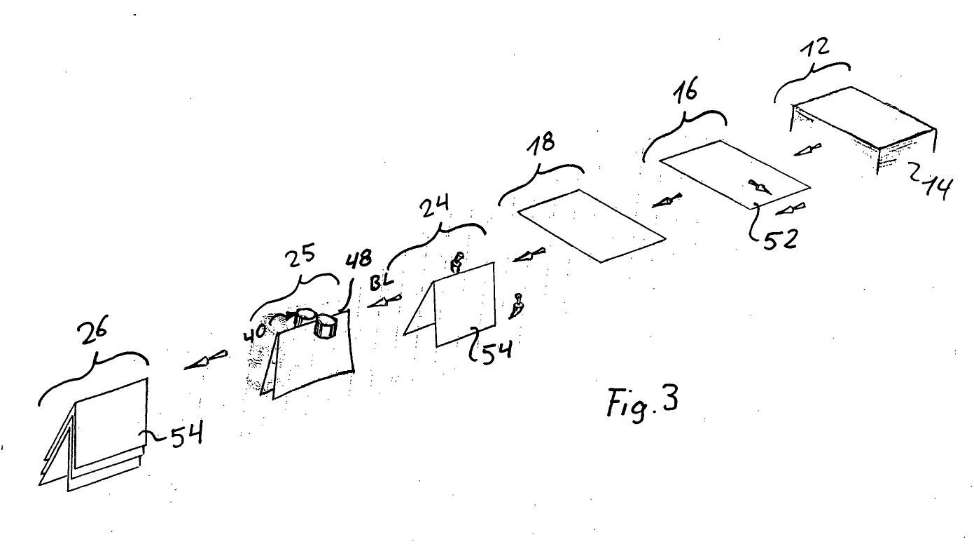

If only four pages of the finished printed product have been printed on the sheet removed from the sheet feeder 12, the operating steps which are shown in FIG. 3 are carried out. These differ merely by the fact that the sheet 52 which is removed from the sheet stack 13 and aligned on the aligning table 16 passes through the buckle folder 18 without being folded. The sheet is folded for the first time, around a folding line running in the sheet-running direction BL, to form a first folded sheet 54 in the former folder 24. All the rest of the operating steps correspond to the operating steps which are shown in FIG. 2.

As is shown in FIGS. 2 and 3, there is no need for the sheets 46, 54, following departure from the former folder 24, to be changed in position in order to be set down in the collating device 26, as a result of which the production capacity can be increased.

What is claimed:

1. A method by means of which sheets which are printed, in particular, by a digital-printing machine are processed further to produce multi-leaf printed products, wherein said printed sheets are folded at least once to form folded sheets, and said folded sheets are collated one above the other, said sheets being folded prior to collation such that the folding edge of said folded sheets is located at the top and said folded sheets open downwardly.

2. The method as claimed in claim 1, wherein said folding edge is pressed prior to collation.

3. An apparatus by means of which sheets which are printed, in particular, by a digital-printing machine are processed further to produce multi-leaf printed products, said apparatus comprising at least one folding device for folding said sheets, downstream of which is provided a collating device, in which said folded sheets are set down one above the other such that a folding edge formed by said folding device is located at the top and said folded sheets open downwardly, wherein said folding device comprises a former folder which opens downwardly.

4. The apparatus as claimed in claim 3, wherein said former folder is provided downstream of a buckle folder.

5. The apparatus as claimed in claim 3, wherein downstream of said former folder a pressing device is provided, which comprises a pair of pressing rollers through which passes said folding edge of a sheet folded by said former folder.
